(19) United States
(12) Patent Application Publication
(10) Pub. No.: US 2020/0372239 A1
(43) Pub. Date: Nov. 26, 2020

(54) DEVICE WAKE-UP BASED ON FINGERPRINT SENSOR

(71) Applicant: Microsoft Technology Licensing, LLC, Redmond, WA (US)

(72) Inventors: Nicolas J-C SCHMITT, Beijing (CN); Weiwei CHEN, Beijing (CN)

(21) Appl. No.: 16/613,693

(22) PCT Filed: May 15, 2017
(86) PCT No.: PCT/CN2017/084340

§ 371 Date: Nov. 14, 2019

(51) Int. Cl. G06K 9/00; G06F 1/3215; G06F 1/16; G06F 13/42

(52) U.S. Cl. CPC G06K 9/00087; G06K 9/0002; G06F 2213/0042; G06F 1/1632; G06F 13/4282; G06F 1/3215

(57) ABSTRACT

Implementations of the subject matter described herein provide a fingerprint authentication solution, which enables the user to use his/her fingerprint to directly wake up the computer from the sleep mode and log in the corresponding account or application, simply by one touch operation on the fingerprint reader. Such one-step “wake-up plus login” operation is realized by the specific controller associated with the fingerprint reader along with the specific driver module at the computer end. In this way, the complexity of login to a computer in a sleep mode can be reduced, and thereby the user's experience is improved.

### BACKGROUND

With the fast development of fingerprint authentication or identification technologies, many electronic devices such as personal computers and tablets nowadays have been integrated with fingerprint authentication components, or can be equipped with external fingerprint authentication accessories. Such fingerprint authentication components/accessories (sometime also referred to as the fingerprint reader) facilitate users' login to their own computers or accounts directly by using the unique personal identity, instead of the long and complex (alphanumeric mixed with symbols) passwords.

### SUMMARY

Conventional fingerprint authentication accessories do not support a wake-up function of the electronic device from a sleep mode. If a user wants to login his/her computer that is currently in a sleep mode, the user normally has to first move/click the mouse or press the keyboard to wake up the computer, and then touch the fingerprint reader to perform the login action. This might be inconvenient since it makes the login action complex.

Implementations of the subject matter described herein provide a fingerprint authentication solution, which enables the user to use his/her fingerprint to directly wake up the computer from the sleep mode and log in the corresponding account or application, simply by one touch operation on the fingerprint reader. Such one-step “wake-up plus login” operation is realized by the specific controller associated with the fingerprint reader along with the specific driver module at the computer end. In this way, the wake-up of device and user authorization can be done in one shot, thereby reducing the user's interaction burden and improving the user experience.

It is to be understood that the Summary is not intended to identify key or essential features of implementations of the subject matter described herein, nor is it intended to be used to limit the scope of the subject matter described herein. Other features of the subject matter described herein will become easily comprehensible through the description below.

### BRIEF DESCRIPTION OF THE DRAWINGS

The above and other objectives, features and advantages of the subject matter described herein will become more apparent through more detailed depiction of example implementations of the subject matter described herein in conjunction with the accompanying drawings, wherein in the example implementations of the subject matter described herein, same reference numerals usually represent same components.

FIG. 1 illustrates a schematic configuration of fingerprint authentication system consisting of a fingerprint reader and an electronic device according to an implementation of the subject matter described herein;

FIGS. 2A and 2B illustrate an example design of the fingerprint reader according to an implementation of the subject matter described herein in different views;

FIGS. 3A-3C illustrate an example design of the fingerprint reader arranged at a dock according to an implementation of the subject matter described herein; and

FIG. 4 illustrates a flowchart of a method implemented at a fingerprint reader, in accordance with one implementation of the subject matter described herein; and

FIG. 5 illustrates a block diagram of an example implementation of the electronic device in which one or more implementations of the subject matter described herein may be implemented.

### DETAILED DESCRIPTION

The subject matter described herein will now be discussed with reference to several example implementations. It should be understood these implementations are discussed only for the purpose of enabling those skilled persons in the art to better understand and thus implement the subject matter described herein, rather than suggesting any limitations on the scope of the subject matter.

As used herein, the term “includes” and its variants are to be read as open terms that mean “includes, but is not limited to.” The term “based on” is to be read as “based at least in part on.” The term “one implementation” and “an implementation” are to be read as “at least one implementation.” The term “another implementation” is to be read as “at least one other implementation.” The terms “first,” “second,” and the like may refer to different or same objects. Other definitions, explicit and implicit, may be included below. A definition of a term is consistent throughout the description unless the context clearly indicates otherwise.

In general, compared to the conventional solutions which do not support the wake-up of the computer by using the fingerprint, implementations of the subject matter enable the user to wake up their computer and log in their account by simply touching the fingerprint reader, without requiring a press on the keyboard or the use of the mouse first to wake up the computer and then performing the login. Now some example implementations will be described merely for illustration.

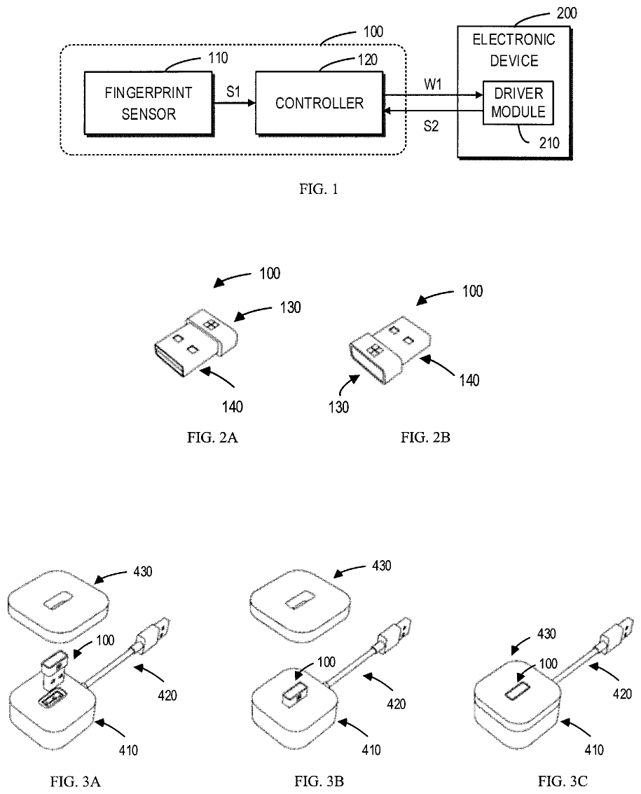

FIG. 1 shows a schematic configuration of a fingerprint authentication system according to an implementation of the subject matter described herein. As shown, a fingerprint reader 100 can be connected to an electronic device 200 which functions as a host machine of the fingerprint reader 100. Examples of the electronic device 200 includes, but are not limited to, personal computer (PC), laptop, tablet, mobile phone, or any other types of fixed or portable devices.

In some implementations, the fingerprint reader 100 can be integrated as part of the electronic device 200. Alternatively, in other implementations, the fingerprint reader 100 can be detachably connected to the electronic device 200 as an external accessory. For example, in some implementations, the fingerprint reader 100 can be plugged into an interface or port of the electronic device 200.

FIGS. 2A-2B show an example implementation of the fingerprint reader 100 in different perspective views, respectively, in accordance with one implementation of the subject matter described herein. In this example, the fingerprint sensor 110 is of a substantially cuboid shape and has a rectangular touch-sensitive head 130 for scanning and receiving the touch from the user. However, it is to be understood that the touch-sensitive head 130 can be of any suitable shape such as a stick, a dome or the like.

In this example, the fingerprint reader 100 further has a connector 140 for enabling a direct coupling of the fingerprint reader 100 to the corresponding interface of the electronic device 200. In some implementations, the connector 140 is a connector conforming to universal serial bus (USB) protocol. It is to be understood that this is merely for illustration without suggesting any limitations as to the scope of the subject matter described herein, and any other types of connector complying with other protocols can also be envisaged according to specific requirement. Moreover, the connector 140 is not limited to the hard-wired connections as illustrated in FIGS. 2A-2C. Rather, wireless connections such as Bluetooth, Wi-Fi, or optical communication are also possible.

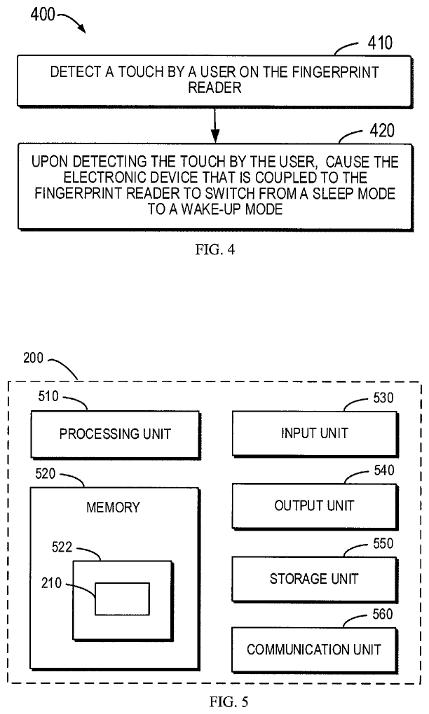

FIGS. 3A-3C show another example implementation of the fingerprint reader 100 that can be connected to the electronic device 200 via a dock 410 according to an implementation of the subject matter described herein. As shown, the connector 140 of the fingerprint reader 100 as described in FIGS. 2A-2B can be plugged into the dock 410, and the dock 410 also has an extension cable 420 for connecting to and communicating with the electronic device 200. Further, the fingerprint reader 100 may also include a cover 430 to seamlessly lock the fingerprint reader 100 in the dock 410 with the touch-sensitive head 130 exposed to the user. Such design as illustrated in FIGS. 3A-3C is especially beneficial for connecting the fingerprint reader 100 to the electronic device 200 which is a desktop computer, for example.

It is to be understood that the described arrangements of the fingerprint reader 100 with respect to the electronic device 200 are only some examples, without suggesting any limitations as to the scope of the subject matter described herein. Any other suitable arraignments are possible as well.

In accordance with implementations of the subject matter described herein, the fingerprint reader 100 includes a fingerprint sensor 110 and controller 120 coupled to one another. The fingerprint sensor 110 can be implemented by a touch-sensitive surface with a spatial resolution that is high enough to detect fingerprint features formed by individual fingerprint ridges. In some implementations, a fingerprint sensor 110 can be used without a separate touch-sensitive surface. In these implementations, the fingerprint sensor 110 can serve as a substitute for many of the functions of the touch-sensitive surface with a much smaller form factor, as the fingerprint sensor 110 can detect movement of a contact over the fingerprint sensor, even when the fingerprint has an area that is as large as or larger than the area of the fingerprint sensor.

Alternatively, in other implementations, the fingerprint sensor 110 may be used in addition to a separate touch-sensitive surface (not shown). In this case, the fingerprint sensor 100 can augment the touch-sensitive surface by providing accurate detection of twisting motions of a contact, identifying different fingerprints of fingers that are used to perform gestures on the fingerprint sensor, and identifying a current user of the host electronic device 200. Furthermore, in implementations where the touch-sensitive surface is used as the fingerprint sensor 110, the term “fingerprint sensor” may refer to the touch-sensitive surface, or a region of the touch-sensitive surface, that is currently in high-resolution mode.

Upon detection of a user's fingerprint, the fingerprint sensor 110 may generate and provide one or more signals to the controller 120 for processing. For example, the controller may authorize the user based on a comparison between the obtained fingerprint and one or more pre-stored fingerprints, which will be discussed later. Specifically, in accordance with implementations of the subject matter described herein, in the case that the electronic device 200 is in a sleep mode, the controller 120, together with a driver module 210 included in the electronic device 200, is configured to cause the electronic device 200 to be “woken up”, i.e., switch from the current sleep mode to a wake-up mode.

As used herein, the phrase “sleep mode” refers to a mode in which an electronic device “pauses” its current state and consumes low power. For example, the power supply to the device can be reduced below a threshold level, the display screen can be turned off; and the like. The phrase “wake-up mode” refers a mode in which the electronic device is fully on and consumes normal power which is larger than that of the “sleep mode”.

In some implementations, the controller 120 is configured to wake up the electronic device 200 in response to detecting a user's touch on the fingerprint sensor 110, without authorizing the user. For example, referring to FIG. 1, upon detection of the touch by the user on fingerprint sensor 110, the fingerprint sensor 110 is operable to send a signal S1 to the controller 120, which in turn sends a wake-up command W1 to the driver module 210 included in the electronic device 20. In response, the driver module 210 may switch the electronic device 200 from the current sleep mode to a wake-up mode. For example, the normal powering can be resumed and the screen display can be switched on.

Then, in some implantations, the driver module 210 may indicate to the controller 120 that the electronic device 200 has been successfully woken up. For example, once the electronic device 200 is woken up, the driver module 210 of the electronic device 200 will send an indication S2 back to the controller 120 to indicate/confirm that the electronic device 200 has been woken up.

In response, the controller 120 may further authorize the user's identity. More specifically, the fingerprint sensor 110, upon detecting the user's touch, may obtain a fingerprint of the user. The fingerprint sensor 110 can detect the touch from the user and capture the user's one or more fingerprints using any of a plurality of touch sensing technologies now known or later developed, including but not limited to capacitive, resistive, infrared, and surface acoustic wave technologies, as well as other proximity sensor arrays or other elements for determining one or more points of contact with surface.

One or more fingerprints of a valid user(s) of the electronic device 200 may be obtained and stored in advance. The one or more fingerprints may be stored at the electronic device 200 and/or the fingerprint reader 100. The controller 120 may compare fingerprint obtained by the fingerprint sensor 110 with the one or more pre-stored fingerprints. If the obtained fingerprint is matched with one of the pre-stored fingerprints, then the user can be authorized. In alternative implementations, the controller 120 may send the obtained fingerprint to the driver module 210 for comparison, for example.

Any fingerprint matching technologies can be used. For example, in some implementations, the fingerprint sensor 110 can capture the user's fingerprint as an image. Then the fingerprint matching can be done based on image processing and comparison. Alternatively, or in addition, the fingerprint images can be converted into a series of analyzed data/parameters. In this case, the comparison may be done based on the extracted data/parameters rather than the actual images. Any other known or later developed fingerprint matching technologies can be used in connection with implementations of the subject matter described herein.

In the example implementations described above, the electronic device 200 is first woken up, and then the user's identity is authorized. In other words, the electronic device 200 will always be woken up from the sleep mode, regardless whether the fingerprint (or user) is one of the registered fingerprints (or users) with the electronic device 200 or not.

Alternatively, in other implementations, the user is first authorized and the electronic device 200 is woken up only if the user authorization succeeds. In such implementations, upon detecting the user's touch, the fingerprint sensor 110 obtains and provides the user's fingerprint to the controller 120 for comparison with one or more pre-stored fingerprints. If the obtained fingerprint matches one of the pre-stored fingerprints, the controller 120 may provide a wake-up command W1 to driver module 210, such that the driver module 210 switches the electronic device 200 from the sleep mode to the wake-up mode.

It will be appreciated that by means of the fingerprint reader 100 described as above, the user may wake up their electronic devices and login the corresponding account or application on the electronic devices by simply touching the fingerprint reader. Compared to the conventional techniques where the user needs to press a keyboard or move the mouse to wake up the electronic device, the fingerprint reader 100 in accordance with implementations of the subject matter described herein enables a safe and more convenient login process.

FIG. 4 illustrates a flowchart of a computer-implemented method 400 implemented at the fingerprint reader 100 in accordance with one implementation of the subject matter described herein. At 410, a touch by a user on the fingerprint reader 100 is detected. At 420, in response to detecting the touch by the user, the electronic device 200 that is coupled to the fingerprint reader 100 is caused to switch from a sleep mode to a wake-up mode. Detailed actions at blocks 410 and 420 and possible other optional actions have been described above and will not be repeated herein.

Hereinafter, an example implementation of the electronic device 200 is shown in FIG. 5. In this example, the electronic device 200 is in a form of a general-purpose computing device. Components of the electronic device 200 may include, but are not limited to, one or more processors or processing units 510, a memory 520, one or more input devices 530, one or more output devices 540, storage 550, and one or more communication units 560. The processing unit 510 may be a real or a virtual processor and is capable of performing various processes in accordance with a program stored in the memory 520. In a multi-processing system, multiple processing units execute computer-executable instructions to increase processing power.

The electronic device 200 typically includes a variety of machine readable medium. Such medium may be any available medium that is accessible by the computing system/server, including volatile and non-volatile medium, removable and non-removable medium.

The memory 520 may be volatile memory (e.g., registers, cache, a random-access memory (RAM)), non-volatile memory (e.g., a read only memory (ROM), an electrically erasable programmable read only memory (EEPROM), a flash memory), or some combination thereof. The storage 550 may be removable or non-removable, and may include machine readable medium such as flash drives, magnetic disks or any other medium which can be used to store information and which can be accessed within the electronic device 20.

The electronic device 200 may further include other removable/non-removable, volatile/non-volatile computing system storage medium. Although not shown in FIG. 5, a disk driver for reading from or writing to a removable, non-volatile disk (e.g., a “floppy disk”), and an optical disk driver for reading from or writing to a removable, non-volatile optical disk can be provided. The memory 120 may include at least one program product having a set (e.g., at least one) of program modules that are configured to carry out the functions of various implementations of the subject matter described herein. The memory 520 may include at least one program product having a set (e.g., at least one) of program modules that are configured to carry out the functions of various implementations of the subject matter described herein.

As illustrated in FIG. 5, a program/utility tool 522 includes the driver module 210 for the fingerprint reader 100 of implementations of the subject matter described herein. In this example, the driver module 210 is implemented as a program module. However, this is merely for purpose of illustration, without suggesting any limitations as to the scope of the subject matter described herein. It is to be understood that the driver module 210 can be implemented by hardware and/or firmware in other implementations.

The input unit(s) 530 may be one or more of various different input devices. For example, the input unit(s) 530 may include a user device such as a mouse, keyboard, trackball, a pointing stick, etc. The input unit(s) 530 may implement one or more natural user interface techniques, such as speech recognition or touch and stylus recognition. As other examples, the input unit(s) 530 may include a scanning device, a network adapter, or another device that provides input to the electronic device 200. The output unit(s) 540 may be a display, printer, speaker, network adapter, or another device that provides output from the electronic device 200. The input unit(s) 530 and output unit(s) 540 may be incorporated in a single system or device, such as a touch screen or a virtual reality system.

The communication unit(s) 560 enables communication over communication medium to another computing entity. Additionally, functionality of the components of the electronic device 200 may be implemented in a single computing machine or in multiple computing machines that are able to communicate over communication connections. Thus, the electronic device 200 may operate in a networked environment using logical connections to one or more other servers, network personal computers (PCs), or another common network node. By way of example, and not limitation, communication media include wired or wireless networking techniques.

The electronic device 200 may also communicate, as required, with one or more external devices (not shown) such as a storage device, a display device, and the like, one or more devices that enable a user to interact with the electronic device 20, and/or any device (e.g., network card, a modem, etc.) that enables the electronic device 200 to communicate with one or more other computing devices. Such communication may be performed via an input/output (I/O) interface(s) (not shown).

The functionally described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the subject matter described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Conversely, various features that are described in the context of a single implementation may also be implemented in multiple implementations separately or in any suitable sub-combination.

Hereinafter, some example implementations of the subject matter described herein will be listed.

In some implementations, a fingerprint reader is provided. The fingerprint reader comprises: an fingerprint sensor operable to: in response to detecting a touch by a user, provide a signal to a controller; and the controller coupled to the fingerprint sensor and configured to: in response to receiving the signal, cause an electronic device to switch from a sleep mode to a wake-up mode, the fingerprint reader being coupled to the electronic device.

In some implementations, the controller is configured to: in response to receiving the signal, obtain a fingerprint of the user captured by the fingerprint sensor; compare the fingerprint with at least one pre-stored fingerprint; and in response to determining that the fingerprint matches the at least one pre-stored fingerprint, provide a wake-up command to the electronic device.

In some implementations, the controller is further configured to: in response to receiving an indication that the electronic device is woken up, facilitate login of an account corresponding to the user on the electronic device.

In some implementations, the controller is configured to: in response to receiving an indication that the electronic device is woken up, obtain the fingerprint of the user captured by the fingerprint sensor; compare the fingerprint with at least one pre-stored fingerprint; and in response to determining that the fingerprint matches the at least one pre-stored fingerprint, facilitate login of an account corresponding to the user on the electronic device.

In some implementations, the fingerprint reader further comprises: a connector for coupling to a dock, the dock having an extension cable for connecting to the electronic device.

In some implementations, the connector complies with a universal serial bus (USB) protocol.

In some implementations, an electronic device is provided. The electronic device comprises: a processing unit; and a driver module, when executed by the processing unit, configured to receive a wake-up command from the fingerprint reader according to present disclosure; and in response to receiving the wake-up command, switch the electronic device from a sleep mode to a wake-up mode.

In some implementations, the driver module is further configured to: in response to the electronic device being woken up, send an indication that the electronic device is woken up to the fingerprint reader.

In some implementations, the driver is further configured to: in response to determining that a fingerprint of the user captured by the fingerprint reader matches at least one pre-stored fingerprint, log in an account corresponding to the user on the electronic device.

In some implementations, a method implemented at a fingerprint reader is provided. The method comprises: detecting a touch by a user on the fingerprint reader; and in response to detecting the touch by the user, causing an electronic device to switch from a sleep mode to a wake-up mode, the fingerprint reader being coupled to the electronic device.

In some implementations, causing an electronic device to switch from a sleep mode to a wake-up mode comprises: in response to detecting the touch, obtaining a fingerprint of the user; comparing the fingerprint with at least one pre-stored fingerprint; and in response to determining that the fingerprint matches the at least one pre-stored fingerprint, providing a wake-up command to the electronic device.

In some implementations, the method further comprises: in response to receiving an indication that the electronic device is woken up, facilitating login of an account corresponding to the user on the host machine.

In some implementations, the method further comprises: in response to receiving an indication that the electronic device is woken up, obtaining the fingerprint from the fingerprint sensor; comparing the fingerprint with at least one pre-stored fingerprint; and in response to determining that the fingerprint matches the at least one pre-stored fingerprint, facilitating login of an account corresponding to the user on the electronic device.

1. A fingerprint reader, comprising:
an fingerprint sensor operable to, in response to detecting a touch by a user, provide a signal to a controller; and
the controller coupled to the fingerprint sensor and configured to, in response to receiving the signal, cause an electronic device to switch from a sleep mode to a wake-up mode, the fingerprint reader being coupled to the electronic device.

2. The fingerprint reader of claim 1, wherein the controller is configured to:
in response to receiving the signal, obtain a fingerprint of the user captured by the fingerprint sensor;
compare the fingerprint with at least one pre-stored fingerprint; and
in response to determining that the fingerprint matches the at least one pre-stored fingerprint, provide a wake-up command to the electronic device.

3. The fingerprint reader of claim 2, wherein the controller is further configured to:
in response to receiving an indication that the electronic device is woken up, facilitate login of an account corresponding to the user on the electronic device.

4. The fingerprint reader of claim 1, wherein the controller is configured to:
in response to receiving an indication that the electronic device is woken up, obtain the fingerprint of the user captured by the fingerprint sensor;
compare the fingerprint with at least one pre-stored fingerprint; and
in response to determining that the fingerprint matches the at least one pre-stored fingerprint, facilitate login of an account corresponding to the user on the electronic device.

5. The fingerprint reader of claim 1, wherein the fingerprint reader further comprises:
a connector for coupling to a dock, the dock having an extension cable for connecting to the electronic device.

6. The fingerprint reader of claim 5, wherein the connector complies with a universal serial bus (USB) protocol.

7. An electronic device, comprising:
a processing unit; and
a driver module, when executed by the processing unit, configured to:
receive a wake-up command from a fingerprint reader; and
in response to receiving the wake-up command, switch the electronic device from a sleep mode to a wake-up mode.

8. The electronic device of claim 7, wherein the driver module is further configured to, in response to the electronic device being woken up, send an indication that the electronic device is woken up to the fingerprint reader.

9. The electronic device of claim 8, wherein the driver is further configured to:
in response to determining that a fingerprint of the user captured by the fingerprint reader matches at least one pre-stored fingerprint, log in an account corresponding to the user on the electronic device.

10. A method implemented at a fingerprint reader, comprising:
detecting a touch by a user on the fingerprint reader; and
in response to detecting the touch by the user, causing an electronic device to switch from a sleep mode to a wake-up mode, the fingerprint reader being coupled to the electronic device.

11. The method of claim 10, wherein causing an electronic device to switch from a sleep mode to a wake-up mode comprises:
in response to detecting the touch, obtaining a fingerprint of the user;
comparing the fingerprint with at least one pre-stored fingerprint; and
in response to determining that the fingerprint matches the at least one pre-stored fingerprint, providing a wake-up command to the electronic device.

12. The method of claim 11, further comprising:
in response to receiving an indication that the electronic device is woken up, facilitating login of an account corresponding to the user on the host machine.

13. The method of claim 10, further comprising:
in response to receiving an indication that the electronic device is woken up, obtaining the fingerprint from the fingerprint sensor,
comparing the fingerprint with at least one pre-stored fingerprint; and
in response to determining that the fingerprint matches the at least one pre-stored fingerprint, facilitating login of an account corresponding to the user on the electronic device.
